(19) United States
(12) Patent Application Publication
(10) Pub. No.: US 2026/0231115 A1
(43) Pub. Date: Aug. 6, 2026

(54) TERMINAL DEVICES AND METHODS FOR SIDELINK COMMUNICATIONS

(71) Applicant: LENOVO (BEIJING) LIMITED, Beijing (CN)

(72) Inventors: Zhennian SUN, Beijing (CN); Haipeng LEI, Beijing (CN); Xiaodong YU, Beijing (CN); Xin GUO, Beijing (CN)

(21) Appl. No.: 19/160,205

(22) PCT Filed: Feb. 28, 2023
(86) PCT No.: PCT/CN2023/078798

§ 371 Date: Aug. 27, 2025

(51) Int. Cl. H04W 72/02; H04W 28/26; H04W 72/044; H04W 72/51; H04W 72/563

(52) U.S. Cl. CPC H04W 72/02; H04W 28/26; H04W 72/046; H04W 72/51; H04W 72/563

(57) ABSTRACT

Embodiments of the present disclosure relate to terminal devices and methods for sidelink communications. A first terminal device determines, based on a reception beam of the first terminal device, a set of resources associated with a resource selection to be performed by a second terminal device, and transmits, to the second terminal device via the transceiver, at least one indication indicative of the set of resources. In this way, the first terminal device may receive a plurality of transmissions from different directions in one sidelink slot at the same time for analog beamforming.

### FIELD

Embodiments of the present disclosure generally relate to the field of communication, and in particular to terminal devices, methods, and a non-transitory computer readable medium for sidelink communications.

### BACKGROUND

In telecommunications networks, such as long term evolution (LTE) networks or new radio (NR) networks, sidelink communications between user equipment (UEs) over a proximity services (ProSe) Communication 5 (PC5) wireless interface may be supported. In sidelink communications, UEs may communicate with each other directly via a PC5 wireless interface on a sidelink channel. Further, sidelink communications may obtain a plurality of benefits, such as coverage extension, service reliability enhancement, and potential low latency.

As discussed in the third generation partnership project (3GPP) release 16 (Rel-16), there are two types of sidelink resource allocation, called sidelink resource allocation mode 1 and sidelink resource allocation mode 2. With the sidelink resource allocation mode 1, the resources for sidelink transmissions are allocated by the network. With the sidelink resource allocation mode 2, the resources for sidelink transmissions are determined by the transmitting (TX) UE based on its sensing. However, there are still some open problems, for example, for resource selection in sidelink communications that will be studied in the near future.

### SUMMARY

In general, embodiments of the present disclosure provide a solution for sidelink communications, for example, for receiving a plurality of transmissions from different directions in one sidelink slot at the same time for analog beamforming.

In a first aspect, there is provided a first terminal device. The first terminal device comprises a processor and a transceiver coupled to the processor. The processor is configured to determine, based on a reception beam of the first terminal device, a set of resources associated with a resource selection to be performed by a second terminal device; and transmit, to the second terminal device via the transceiver, at least one indication indicative of the set of resources or reception beams collision.

In a second aspect, there is provided a second terminal device. The second terminal device comprises a processor and a transceiver coupled to the processor. The processor is configured to receive, from a first terminal device via the transceiver, at least one indication indicative of a set of resources associated with a resource selection to be performed by the second terminal device or reception beams collision, wherein the set of resources is determined based on a reception beam of the first terminal device; and perform the resource selection based on the at least one indication.

In a third aspect, there is provided a method performed by a first terminal device. The method comprises determining, based on a reception beam of the first terminal device, a set of resources associated with a resource selection to be performed by a second terminal device; and transmitting, to the second terminal device via a transceiver, at least one indication indicative of the set of resources or reception beams collision.

In a fourth aspect, there is provided a method performed by a second terminal device. The method comprises receiving, from a first terminal device via a transceiver, at least one indication indicative of a set of resources associated with a resource selection to be performed by the second terminal device or reception beams collision, wherein the set of resources is determined based on a reception beam of the first terminal device; and performing the resource selection based on the at least one indication.

In a fifth aspect, there is provided a non-transitory computer readable medium. The non-transitory computer readable medium having program instructions stored thereon. The program instructions, when executed by an apparatus, causing the apparatus at least to: determine, based on a reception beam of a first terminal device, a set of resources associated with a resource selection to be performed by a second terminal device; and transmit, to the second terminal device via a transceiver, at least one indication indicative of the set of resources or reception beams collision.

In a sixth aspect, there is provided a non-transitory computer readable medium. The non-transitory computer readable medium having program instructions stored thereon. The program instructions, when executed by an apparatus, causing the apparatus at least to: receive, from a first terminal device via a transceiver, at least one indication indicative of a set of resources associated with a resource selection to be performed by a second terminal device or reception beams collision, wherein the set of resources is determined based on a reception beam of the first terminal device; and perform the resource selection based on the at least one indication.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates a schematic diagram of a communication environment in which some embodiments of the present disclosure can be implemented;

FIG. 2 illustrates a schematic diagram showing a process of communication between a first terminal device and a second terminal device in accordance with some embodiments of the present disclosure;

FIG. 3 illustrates a schematic diagram showing determination of at least one resource by a first terminal device for resource selection of a second terminal device in accordance with some embodiments of the present disclosure;

FIG. 4 illustrates a schematic diagram showing determination of at least one resource by a first terminal device for resource selection of a second terminal device in accordance with some other embodiments of the present disclosure;

FIG. 5 illustrates a flowchart of an example method for communication in accordance with some embodiments of the present disclosure;

FIG. 6 illustrates a flowchart of an example method for communication in accordance with some other embodiments of the present disclosure;

FIG. 7 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term: “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

Sidelink operation on FR2 licensed spectrum has been approved in the WID of R18 sidelink evolution with following objective.

Study and specify enhanced sidelink operation on FR2 licensed spectrum [RAN1,
RAN2, RAN4] (This part of the work is put on hold until further checking in
RAN#97)
Update evaluation methodology for commercial deployment scenario
Work is limited to the support of sidelink beam management (including initial
beam-pairing, beam maintenance, and beam failure recovery, etc) by reusing existing
sidelink CSI framework and reusing Uu beam management concepts wherever
possible.
Beam management in FR2 licensed spectrum considers sidelink unicast
communication only.

For sidelink operation on FR2 analog beamforming should be supported, for analog beamforming the terminal device (e.g. UE) could only form one beam to one direction at the same time. In sidelink system one sidelink UE could communicate to multiple sidelink UEs at the same. In sidelink resource allocation mode 2 one UE determines resources for sidelink transmission based on sensing, however due to limitation of capability to form RX beam at the RX UE side, the TX UE may select unsuitable resources on which the RX UE cannot perform proper RX beam to receive the sidelink transmissions on those resources. The skilled in the art should understand that a RX beam is also referred to a reception beam, a RX UE is also referred to a reception UE, as well as a TX UE is also referred to a transmission UE.

For example, a terminal device (e.g. UE1) would perform sidelink receptions from other terminal devices (e.g. UE 2/3/4) at the same time, if legacy sidelink resource allocation scheme is applied at UE2/3/4, e.g., perform resource selection of mode 2 independently, in some slot the UE1 may need to receive PSSCHs from different UEs with different RX beams, for example, in some slots (e.g. slot n/n+3/n+7, n is a positive integer), UE1 has to perform sidelink reception from different directions and the associated RX beams are different. If UE1 only supports analog beamforming, it cannot perform such reception.

As to an UE procedure for determining the subset of resources to be reported to higher layers in PSSCH resource selection in sidelink resource allocation mode 2, In resource allocation mode 2, the higher layer can request the UE to determine a subset of resources from which the higher layer will select resources for PSSCH (physical sidelink share channel)/PSCCH (physical sidelink control channel) transmission. To trigger this procedure, in slot n, the higher layer provides the following parameters for this PSSCH/PSCCH transmission:
The resource pool from which the resources are to be reported;
L1 priority, prio_{TX};
The remaining packet delay budget;
The number of sub-channels to be used for the PSSCH/PSCCH transmission in a slot, L_{subCH};
Optionally, the resource reservation interval, P_{rsvp_TX}, in units of msec.
If the higher layer requests the UE to determine a subset of resources from which the higher layer will select resources for PSSCH/PSCCH transmission as part of re-evaluation or pre-emption procedure, the higher layer provides a set of resources (r₀, r₁, r₂, . . . ) which may be subject to re-evaluation and a set of resources

$$( {r}_{0}^{′} , {r}_{1}^{′} , {r}_{2}^{′} , … )$$

which may be subject to pre-emption.
It is up to UE implementation to determine the subset of resources as requested by higher layers before or after the slot

$${r}_{i}^{″} - {T}_{3} , where {r}_{i}^{″}$$

is the slot with the smallest slot index among (r₀, r₁, r₂, . . . ) and

$$( {r}_{0}^{′} , {r}_{1}^{′} , {r}_{2}^{′} , … ) ,$$

and T₃ is equal to

$${T}_{proc , 1}^{SL} , where {T}_{proc , 1}^{SL}$$

is defined in slots in Table 8.1.4-2 where μ_{SL} is the SCS configuration of the SL BWP.

The following higher layer parameters affect this procedure:
sl-SelectionWindowList: internal parameter T₂ min is set to the corresponding value from higher layer parameter sl-SelectionWindowList for the given value of prio_{TX};
sl-Thres-RSRP-List: this higher layer parameter provides an RSRP threshold for each combination (pᵢ,pⱼ), where pᵢ is the value of the priority field in a received SCI format 1-A and pⱼ is the priority of the transmission of the UE selecting resources; for a given invocation of this procedure, pⱼ=prio_{TX};
sl-RS-ForSensing selects if the UE uses the PSSCH-RSRP or PSCCH-RSRP measurement, as defined in clause 8.4.2.1;
sl-ResourceReservePeriodList;
sl-SensingWindow: internal parameter T₀ is defined as the number of slots corresponding to sl-SensingWindow msec;
sl-TxPercentageList: internal parameter X for a given prio_{TX} is defined as sl-TxPercentageList (prio_{TX}) converted from percentage to ratio;
sl-PreemptionEnable: if sl-PreemptionEnable is provided, and if it is not equal to ‘enabled’, internal parameter prioₚᵣₑ is set to the higher layer provided parameter sl-PreemptionEnable;
The resource reservation interval, P_{rsvp_TX}, if provided, is converted from units of msec to units of logical slots, resulting in

$${P}_{rsvp \_ TX}^{′}$$

according to clause 8.1.7.

It should be noted that

$$( {t}_{0}^{′SL} , {t}_{1}^{′SL} , {t}_{2}^{′SL} , … )$$

denotes the set of slots which belongs to the sidelink resource pool and is defined in Clause 8.

The following steps are used:
1) A candidate single-slot resource for transmission R is defined as a set of L_{subCH} contiguous sub-channels with sub-channel x+j in slot

$${t}_{y}^{′SL}$$

where j=0, . . . , L_{subCH}−1. The UE shall assume that any set of L_{subCH} contiguous sub-channels included in the corresponding resource pool within the time interval [n+T₁, n+T₂] correspond to one candidate single-slot resource, where selection of T₁ is up to UE implementation under

$$0 \leq {T}_{1} \leq {T}_{proc , 1}^{SL} ,$$

$$where$$

$${T}_{proc , 1}^{SL}$$

is defined in slots in Table 8.1.4-2 where μ_{SL} is the SCS configuration of the SL BWP; if T₂ₘᵢₙ is shorter than the remaining packet delay budget (in slots) then T₂ is up to UE implementation subject to T₂ₘᵢₙ≤T₂≤remaining packet delay budget (in slots); otherwise T₂ is set to the remaining packet delay budget (in slots). The total number of candidate single-slot resources is denoted by Mₜₒₜₐₗ.
2) The sensing window is defined by the range of slots

$$[ n - {T}_{0} , n - {T}_{proc , 0}^{SL} )$$

where T₀ is defined above and

$${T}_{proc , 0}^{SL}$$

is defined in slots in Table 8.1.4-1 where μ_{SL} is the SCS configuration of the SL BWP. The UE shall monitor slots which belongs to a sidelink resource pool within the sensing window except for those in which its own transmissions occur. The UE shall perform the behaviour in the following steps based on PSCCH decoded and RSRP measured in these slots.
3) The internal parameter Th(pᵢ,pⱼ) is set to the corresponding value of RSRP threshold indicated by the i-th field in sl-Thres-RSRP-List, where i=pᵢ+(pⱼ−1)*8.
4) The set S_{A} is initialized to the set of all the candidate single-slot resources.
5) The UE shall exclude any candidate single-slot resource R_{x,y} from the set S_{A} if it meets all the following conditions: the UE has not monitored slot

$${t}_{m}^{′SL}$$

in Step 2; for any periodicity value allowed by the higher layer parameegl-REesourceReservePeriodList and a hypothetical SCI format 1-A received in slot

$${t}_{m}^{′SL}$$

with ‘Resource reservation period’ field set to that periodicity value and indicating all subchannels of the resource pool in this slot, condition c in step 6 would be met.
5a) If the number of candidate single-slot resources R_{x,y} remaining in the set S_{A} is smaller than X·Mₜₒₜₐₗ, the set S_{A} is initialized to the set of all the candidate single-slot resources as in step 4.
6) The UE shall exclude any candidate single-slot resource R_{x,y} from the set S_{A} if it meets all the following conditions: a) the UE receives an SCI format 1-A in slot

$${t}_{m}^{′SL} ,$$

and ‘Resource reservation period’ field, if present, and ‘Priority’ field in the received SCI format 1-A indicate the values P_{rsvp_RX} and prio_{RX}, respectively according to Clause 16.4 in [6, TS 38.213]; b) the RSRP measurement performed, according to clause 8.4.2.1 for the received SCI format 1-A, is higher than Th(prio_{RX},prio_{TX}); c) the SCI format received in slot

$${t}_{m}^{′SL}$$

or the same SCI format which, if and only if the ‘Resource reservation period’ field is present in the received SCI format 1-A, is assumed to be received in slot(s)

$${t}_{m + q \times {P}_{rsvp \_ R X}^{′}}^{′SL}$$

determines according to clause 8.1.5 the set of resource blocks and slots which overlaps with

$${R}_{x , y + j \times {P}_{rsvp \_ TX}^{′}}$$

for q=1, 2, . . . , Q and j=0, 1 . . . , Cᵣₑₛₑₗ−1. Here,

$${P}_{rsvp \_ RX}^{′}$$

is P_{rsvp_RX} converted to units of logical slots according to clause 8.1.7,

$$Q = ⌈ \frac{{T}_{scal}}{{P}_{rsvp \_ RX}} ⌉$$

if P_{rsvp_RX}≤T_{scal} and

$${n}^{′} - m \leq {P}_{rsvp \_ RX}^{′} ,$$

$$where$$

$${t}_{{n}^{′}}^{′SL} = n$$

if slot n belongs to the set

$$( {t}_{0}^{′SL} , {t}_{1}^{′SL} , … , {t}_{{{T}^{′}}_{max} - 1}^{′SL} ) ,$$

otherwise slot

$${t}_{{n}^{′}}^{′SL}$$

is the first slot after slot n belonging to the set

$$( {t}_{0}^{′SL} , {t}_{1}^{′SL} , … , {t}_{{{T}^{′}}_{max} - 1}^{′SL} ) ;$$

otherwise Q=1. T_{scal} is set to selection window size T2 converted to units of msec.
7) If the number of candidate single-slot resources remaining in the set S_{A} is smaller than X·Mₜₒₜₐₗ, then Th(pᵢ,pⱼ) is increased by 3 dB for each priority value Th(pᵢ,pⱼ) and the procedure continues with step 4.

The UE shall report set S_{A} to higher layers.

As to an UE procedure for determining a set of preferred or non-preferred resources for another UE's transmission, when this procedure is triggered, the following parameters are provided by the higher layer:
the resource pool from which the preferred or non-preferred resources are to be determined;
the resource selection window [n+T₁, n+T₂] within which the preferred or non-preferred resources are to be determined;
the resource set type (either preferred or non-preferred resource set);
if the resource set type indicates preferred set, then the higher layer additionally provides the following parameters:
L1 priority, prio_{TX};
the number of sub-channels to be used for the PSSCH/PSCCH transmission in a slot, L_{subCH};
the resource reservation period, P_{rsvp_TX}, if present.

The value of Cᵣₑₛₑₗ is determined by the UE according to clause 8.1.5.

When this procedure is triggered by another UE's explicit request, the fields in the request are interpreted as follows:
The field ‘Resource selection window location’ is the concatenation of the starting time location and the ending time location of the resource selection window. The starting and ending time locations of the resource selection window are each encoded in the same way as the reference slot as described in clause 8.1.5A.
The field ‘Resource reservation period’ is encoded in the same way as the field of the same name in SCI format 1-A.

When determining a preferred resource set, the UE applies the procedure described in clause 8.1.4 with the above parameters and the following modifications:
Step 6a) The UE excludes candidate single-slot resource(s) belonging to slot(s) where the UE does not expect to perform SL reception of a TB due to half-duplex operation, if all the following conditions are met:
the UE is a destination UE of the TB for whose transmission the preferred resource set is being determined;
the higher layer parameter sl-Considionl-A-2 is not set to ‘Disabled’.

When determining a non-preferred resource set, the UE considers any resource(s) within the resource selection window, if indicated by a received explicit request, and satisfying at least one of the following conditions as non-preferred resource(s):
resource(s) indicated by a received [SCI format 1-A], satisfying at least one of the following criteria:
the RSRP measurement performed, according to clause 8.4.2.1, for the received [SCI format 1-A], is higher than Th(prio_{RX}) where prio_{RX} is the value of the priority field in the received [SCI format 1-A]. The internal parameter Th(pᵢ) is set to the corresponding value of RSRP threshold indicated by the k-th field in sl-ThresholdRSRP-Condition1-B-1-OptionList, where k=pᵢ.
the UE is a destination UE of a TB associated with the received [SCI format 1-A] and the RSRP measurement performed, according to clause 8.4.2.1 for the received [SCI format 1-A], is lower than Th′(prio_{RX}) where prio_{RX} is the value of the priority field in the received [SCI format 1-A]. The internal parameter Th′(pᵢ) is set to the corresponding value of RSRP threshold indicated by the k-th field in sl-ThresholdRSRP-Condition1-B-1-Option2List, where k=pᵢ.
resources(s) in slot(s) in which the UE does not expect to perform SL reception due to half duplex operation, if the UE is a destination UE of a TB for whose transmission the non-preferred resource set is being determined.

Since sidelink system is a distributed system, e.g., one sidelink RX UE may communicate with multiple sidelink TX UEs located in different directions, for sidelink operation on FR2 to compensate the pathloss on higher frequency the UE shall use beamforming to transmit/receive the signal. For analog beamforming the RX UE could only form only RX beam to receive one direction at one time, however if multiple TX UE's transmissions from different directions are FDMed (Frequency domain multiplexing) in one sidelink slot, the RX UE could not receive them at the same time for analog beamforming. In view of the above discussions, embodiments of the present disclosure provide a solution for address this issue above.

Principles and implementations of embodiments of the present disclosure will be described in detail below with reference to the figures.

### Example Environment

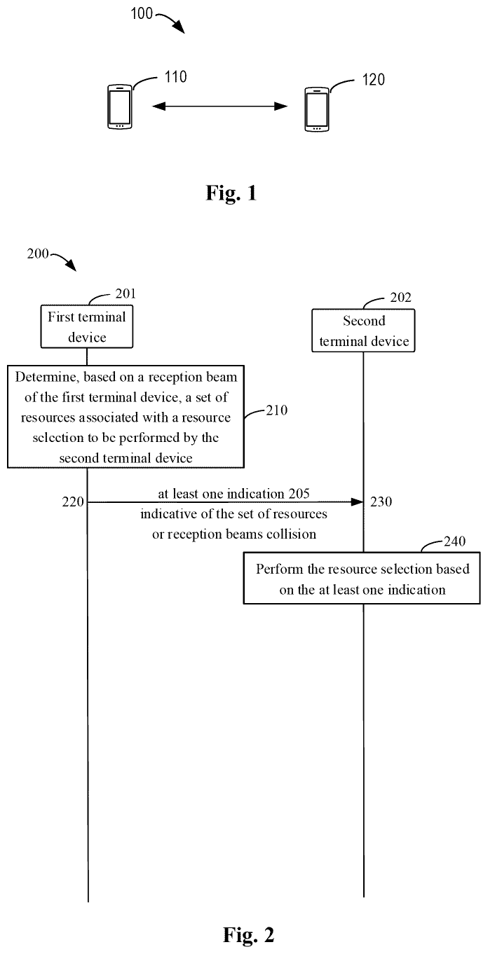

Reference is first made to FIG. 1, which illustrates a schematic diagram of a communication environment 100 in which some embodiments of the present disclosure can be implemented. As shown in FIG. 1, the communication environment 100, which may be a part of a communication network, comprises terminal devices 110 and 120.

As an example, the terminal devices 110 and 120 may perform a sidelink transmission, which is also referred to as a device-to-device (D2D) communication. Just for the purpose of discussion, in some example embodiments, the terminal device 110 will be taken as an example of a RX device of a sidelink transmission. The terminal device 120 will be taken as an example of an TX device that initiates the sidelink transmission. As another example, the terminal devices 110 and/or 120 may communicate with one or more further terminal devices not shown in FIG. 1.

The communication environment 100 may further comprise a network device (not shown in FIG. 1). To transmit data and/or control information, the terminal devices 110 and 120 may perform communications with the network device, respectively. For transmissions from the network device to the terminal device 110 or 120, the communication link may be referred to as a downlink, whereas for transmissions from the terminal device 110 or 120 to the network device, the communication link may be referred to as an uplink.

In some embodiments, the network device may be absent in the communication environment 100. In other words, the terminal devices 110 and 120 as well as possibly other terminal devices (not shown) may be outside of the coverage range of the network device. In such cases, only sidelink communications may exist between the terminal devices 110 and 120, and possibly other terminal devices not shown in FIG. 1.

Although the terminal devices 110 and 120, and the network device are described in the communication environment 100 of FIG. 1, embodiments of the present disclosure may equally apply to any other suitable communication devices in communication with one another. That is, embodiments of the present disclosure are not limited to the exemplary scenarios of FIG. 1. In this regard, it is noted that although the terminal devices 110 and 120 are schematically depicted as mobile phones and the network device is schematically depicted as a base station in FIG. 1, it is understood that these depictions are exemplary in nature without suggesting any limitation. In other embodiments, the terminal devices 110 and 120, and the network device may be any other communication devices, for example, any other wireless communication devices.

It is to be understood that the particular number of various communication devices and the particular number of various communication links as shown in FIG. 1 is for illustration purpose only without suggesting any limitations. The communication environment 100 may include any suitable number of communication devices and any suitable number of communication links for implementing embodiments of the present disclosure. In addition, it should be appreciated that there may be various wireless as well as wireline communications (if needed) among all of the communication devices.

The communications in the communication environment 100 may follow any suitable communication standards or protocols, which are already in existence or to be developed in the future, such as universal mobile telecommunications system (UMTS), long term evolution (LTE), LTE-advanced (LTE-A), the fifth generation (5G) new radio (NR), wireless fidelity (Wi-Fi) and worldwide interoperability for microwave access (WiMAX) standards, and employs any suitable communication technologies, including, for example, multiple-input multiple-output (MIMO), orthogonal frequency division multiplexing (OFDM), time division multiplexing (TDM), frequency division multiplexing (FDM), code division multiplexing (CDM), bluetooth, ZigBee, and machine type communication (MTC), enhanced mobile broadband (eMBB), massive machine type communication (mMTC), ultra-reliable low latency communication (URLLC), carrier aggregation (CA), dual connectivity (DC), and new radio unlicensed (NR-U) technologies.

### Example Method

FIG. 2 illustrates a schematic diagram showing a process 200 of communication between a first terminal device 201 and a second terminal device 202 in accordance with some embodiments of the present disclosure. In some embodiments, the first terminal device 201 may be the terminal device 110, and the second terminal device 202 may be the terminal device 120. In some embodiments, the first terminal device 201 may comprise a processor (may be referred to as a first processor), and a transceiver (may be referred to as a first transceiver) coupled to the first processor. In some embodiments, the second terminal device 202 may comprise a processor (may be referred to as a second processor), and a transceiver (may be referred to as a second transceiver) coupled to the second processor.

As shown in FIG. 2, the first terminal device 201 may determine (210), based on a reception beam (i.e. a current reception beam) of the first terminal device 201, a set of resources associated with a resource selection to be performed by the second terminal device 202. The first terminal device 201 may transmit (220), to the second terminal device 202 via the transceiver (the first transceiver), at least one indication 205 indicative of the set of resources or reception beams collision. On the second terminal device 202 side, the second terminal device 202 may receive (230), from a first terminal device 201 via the transceiver (the second transceiver), the at least one indication 205 indicative of the set of resources associated with the resource selection to be performed by the second terminal device 202, wherein the set of resources is determined based on a reception beam of the first terminal device 201. The second terminal device 202 may perform (240) the resource selection based on the at least one indication 205. To be more particularly, the reception beam, based on which the set of resource for the second terminal device 202 is determined, can be a reception beam for a communication with a third terminal device, or a reception beam on which the first terminal device has been operated.

The process 200 can be implemented by various embodiments of two main schemes, the first main scheme to implement the process 200 is described below, and specific examples of the first main scheme may be referred to Alt.1 below.

In some embodiments, the set of resources are determined based on a first set of resources in a set of slots reserved for a third terminal device, for which the reception beam of first terminal device 201 is associated with the reception beam for the second terminal device 202. Additionally, in some embodiments, the set of resources are determined based on a second set of resources in a set of slots which are not reserved for a transmission to the first terminal device 201. Herein the third terminal device may be a further terminal device different from the first terminal device 201 and the second terminal device 202.

In some embodiments, the first terminal device 201 determines the set of resources, specifically, the first terminal device 201 may select part or all of resources from the first set of resources. In other words, in some embodiments, the set of resources may comprise part or all of resources from the first set of resources in a set of slots, and the first set of resources are reserved for the third terminal device, for which the reception beam of the first terminal device is associated with the reception beam for the second terminal device 202.

Additionally, in some embodiments, the set of resources may comprise part or all of resources from the second set of resources in a set of slots which are not reserved for a transmission to the first terminal device 201. In other words, in some embodiments, in order to determine the set of resources, the first terminal device 201 may select part or all of resources from the first set of resources and the second set of resources.

In some embodiments, the set of resources are determined based on excluding a third set of resources in a set of slots, and the third set of resources are reserved for other terminal devices for which the reception beam of the first terminal device is different from the reception beam of the first terminal device for the second terminal device 202.

In some embodiments, the first terminal device 201 determines the set of resources, specifically, the first terminal device 201 may select the set of resources from the first set of resources, in the case that a number of the first set of resources is not below a predefined threshold number or ratio. In other words, the set of resources may comprise part or all of resources from the first set of resources in the case that a number of the first set of resources is not below the predefined threshold number or ratio.

In some embodiments, the first terminal device 201 determines the set of resources, specifically, the first terminal device 201 may select the set of resources from the first set of resources and the second set of resources, in the case that a number of the first set of resources is below a predefined threshold number or ratio. For example, in some embodiments, in the case that a number of the first set of resources is below a predefined threshold number or ratio, the set of resources may comprise: all of resources from the first set of resources, and part or all of resources from the second set of resources.

In some embodiments, the first terminal device 201 transmits the at least one indication, specifically, the first terminal device 201 may transmit a first indication indicative of a first subset of resources selected from the first set of resources and a second indication indicative of a second subset of resources selected from the second set of resources. On the second terminal device 202 side, the second terminal device 202 may receive the first indication indicative of the first subset of resources selected from the first set of resources and the second indication indicative of the second subset of resources selected from the second set of resources. In these embodiments, the set of resources in FIG. 2 may comprises two parts: the first subset of resources and the second subset of resources. For the second terminal device 202, it may consider the first subset of resources first during its resource selection procedure.

In some other embodiments, the first terminal device 201 transmits the at least one indication, specifically, the first terminal device 201 may transmit an indication indicative of resources selected from the first set of resources and the second set of resources. On the second terminal device 202 side, the second terminal device 202 may receive the indication indicative of the resources selected from the first set of resources and the second set of resources. In these embodiments, on the second terminal device 202 side, the first subset of resources and the second subset of resources are not distinguished during the resource selection procedure.

In some embodiments, the at least one indication may comprise a bitmap, for example, each bit in the bitmap may represent whether some resources in one slot are of the set of resources associated with a resource selection to be performed by the second terminal device 202. In some other embodiments, the at least one indication may comprise a combination of a time resource indicator value and a frequency resource indicator value.

In some embodiments, the first terminal device 201 may transmit, to the second terminal device 202 via the transceiver, capability information of the first terminal device 201 whether analog beamforming is supported at the first terminal device 201. On the second terminal device 202 side, the second terminal device 202 may receive the capability information above.

In some embodiments, on the second terminal device 202 side, to perform the resource selection, the second terminal device 202 may exclude a plurality of resources not comprised in the set of resources from a candidate resource set, and may determine a set of selected resources from the candidate resource set excluding the plurality of resources.

The second main scheme to implement the process 200 is described below, in addition, specific examples of the second main scheme may be referred to Alt.2 below.

In some embodiments, in the case that a reception beam associated with a fourth set of resources in a set of slots reserved for the second terminal device is different with a reception beam associated with a fifth set of resources in the set of slots reserved for a third terminal device, the first terminal device 201 transmits the at least one indication indicative of the reception beams collision. On the second terminal device 202 side, the second terminal device 202 may receive the at least one indication indicative of the reception beams collision.

In some embodiments, the at least one indication may be transmitted in the case that a priority associated with the fourth set of resources is lower than a priority associated with the fifth set of resources. Accordingly, on the second terminal device 202 side, the at least one indication may be received in the case that the priority associated with the fourth set of resources is lower than the priority associated with the fifth set of resources.

In some embodiments, the at least one indication may be transmitted in the case that a number of resources among the second set of resources is less than a number of resources among the first set of resources. Accordingly, on the second terminal device 202 side, the at least one indication may be received in the case that a number of resources among the fourth set of resources is less than a number of resources among the fifth set of resources.

In some embodiments, on the second terminal device 202 side, to perform the resource selection, the second terminal device 202 may determine a set selected resources from a candidate resource set excluding resources associated with the reception beams collision.

With continued reference to the process 200, some embodiments of the present disclosure will be further described below. The first main scheme and the second main scheme mentioned above may correspond to Alt.1 and Alt.2 respectively.

In some embodiments, the first terminal device 201 may be a RX UE, for example, a first UE. The second terminal device 202 may be a TX UE, for example, the second terminal device 202 is a second UE.

As mentioned above, since sidelink system is a distributed system, e.g., one sidelink RX UE may communicate with multiple sidelink TX UEs located in different directions, for sidelink operation on FR2 to compensate the pathloss on higher frequency the UE shall use beamforming to transmit/receive the signal. For analog beamforming the RX UE could only form only RX beam to receive one direction at one time, however if multiple TX UE's transmissions from different directions are FDMed in one sidelink slot, the RX UE could not receive them at the same time for analog beamforming. In order to address the issue above, three alternatives (Alt.1-Alt.3) are proposed in the embodiments of the present disclosure.

As to Alt.1, in some embodiments, the RX UE may transmit, to the TX UE, a set of preferred resources determined based on its associated RX beam and the reservation of other UEs, and the TX UE may consider this set of preferred resources during its resource selection procedure. This set of preferred resources is an example of a set of resources associated with a resource selection to be performed by a second terminal device 202. Alt.1 are further described in detail below.

In some embodiments, the TX UE and the RX UE could exchange the capability on the beamforming, e.g., only support analog beamforming at RX UE side.

For the unicast communication between the TX UE and the RX UE, the RX UE could determine a set of preferred resources for the TX UE's transmission based on the associated RX beam and the reservations of other UEs. The details on how to determine this set of preferred resources could be as following: In some embodiments, the first UE (i.e. the RX UE) may firstly exclude a set of resources (an example of the third set of resources) with following conditions: detected reservations from other UEs and the first UE is the reception UE of these reservations; and the associated RX beam with the second UE (TX UE) is different to the associated RX beam with the other UEs above (in other words, the first UE could not form one beam to perform receptions from both second UE and another UE at the same time).

If above conditions are meet, the first UE could exclude the all the resources (the third set of resources) in this slot, after this step there are two type of resources may be existed in the remaining slots, type 1: the resources in the slot that has reservation from a third UE (an example of the third terminal device) and the associated RX beams from the second UE and the third UE are the same (or to say the first UE could form one RX beam to receive the transmissions from the second UE and the third UE and the same time); type 2: the resources in the slot that has no reservation for the transmissions to the first UE. The resources of type 1 (or be referred to as type 1 resources) may be an example of the first set of resources in a set of slots reserved for the third terminal device associated with the reception beam for the second terminal device 202. The resources of type 2 (or be referred to as type 2 resources) may be an example of the second set of resources in a set of slots not reserved for a transmission to the first terminal device 201.

Secondly the first UE may further determine the preferred resources for the second UE's transmission from the remaining slots which are not excluded in the above step. In this step, one of the following options (option 1-option 3) could be considered.

Option 1, in some embodiments, the first UE may determine the preferred resources for the second UE's transmission on in the slots which contain reservations from the third UE and the associated RX beam with the third UE and the associated RX beam with the second UE are the same (or to say one RX beam could perform receptions from the second UE and the third UE at the same time), e.g., only determines the preferred resources for the second UE's transmission from type 1 resources. That is, in some embodiments, the set of resources associated with a resource selection to be performed by a second terminal device 202 may be determined based on the first set of resources mentioned above, for example, the first terminal device 201 may select part or all of resources from the first set of resources to determine the set of resources associated with a resource selection to be performed by a second terminal device 202. This option has benefit to align the sidelink receptions with same RX beam in one slot and with the feasibility to perform receptions with other beams in the slots without reservations.

Option 2, in some embodiments, up to UE implementation to determine which resources could be as preferred resources in the remaining resources, since the transmissions on the remaining resources will not cause RX beam collision at the first UE side, the first UE may determine a full set or a subset of resources among the remaining resources as preferred resources, e.g., determines the preferred resources for the second UE's transmissions from both type 1 resources and type 2 resources. That is, in some embodiments, the set of resources associated with a resource selection to be performed by the second terminal device 202 may be determined based on the first set of resources and the second set of resources mentioned above, for example, the first terminal device 201 may select part or all of resources from the first set of resources and the second set of resources.

Option 3, in some embodiments, the first UE may firstly consider the resources from type 1 resources. If the resources in type 1 resources are not enough, e.g., less than a threshold or a ratio (number of type 1 slots/number of slots within the second UE's resource selection window), then the first UE may further consider the resources in type 2 resources. The threshold or the ratio could be (pre-)configured. That is, in some embodiments, in order to determine the set of resources, the first terminal device 201 may select the set of resources from the first set of resources associated with a resource selection to be performed by a second terminal device 202, in the case that a number of the first set of resources is not below a predefined threshold number or ratio. In some embodiments, in order to determine the set of resources, the first terminal device 201 may select the set of resources from the first set of resources and the second set of resources, in the case that a number of the first set of resources is below a predefined threshold number or ratio.

In this option 3 on the indication of preferred resources to the second UE, two approaches could be further considered. In some embodiments, approach 1: the first UE may transmit two sets of preferred resources to the second UE, a first set of preferred resources for the second UE's transmission are the resources determined from type 1 resources, and a second set of preferred resources for the second UE's transmission are the resources determined from type 2 resources. That is, in some embodiments, the first terminal device 201 may transmit a first indication indicative of a first subset of resources (for example the first set of preferred resources) selected from the first set of resources and a second indication indicative of a second subset of resources (for example the second set of preferred resources) selected from the second set of resources. In this way, the second UE may be based on the first indication and the second indication, first consider the selected type1 resources (the first subset of resources) in the resource selection procedure.

In some embodiments, approach 2: the first UE only transmits one set of preferred resources to the second UE containing both the resources determined from type 1 and type 2 resources. That is, in some embodiments, the first terminal device 201 may transmit an indication indicative of resources (for example, the one set of preferred resources) selected from the first set of resources (for example, the type 1 resources) and the second set of resources (for example, the type 2 resources). In this way, the second UE may consider the selected type 1 resources (the first subset of resources) and the selected type 2 resources (the second subset of resources) fairly in the resource selection procedure.

In some embodiments, on the indication of preferred resources determined with above steps to the second UE, following option1 or option 2 could be considered:

In some embodiments, option 1: the preferred resources may be indicated in a bitmap, for example, in some embodiments, each bit in the bitmap may represent whether the resources in one slot are the preferred resources for the second UE's transmission.

In some embodiments, option 2: combination of TRIV (time resource indicator value), FRIV (frequency resource indicator value) is used to indicate one identified resource among the resources determined with above steps.

In some embodiments, on the second UE (is the TX UE) side, after receiving the indicated preferred resources from the first UE, the second UE shall consider the preferred resources during its resource selection procedure. In some embodiments, for sidelink resource allocation mode 2, the second UE may also determine a set of resources based on its sensing (candidate resource set). During the resource selection, the second UE may exclude the resources not indicated in the preferred resources from its candidate resource set, and performs the resource selection from the remaining resources in the candidate resource set (or to say perform the resource selection from the intersection between the preferred resources and its own candidate resource set). In other words, in some embodiments, in order to perform the resource selection, the second terminal device 202 may exclude a plurality of resources not comprised in the set of resources from the candidate resource set, and determine a set of selected resources from the candidate resource set excluding the plurality of resources.

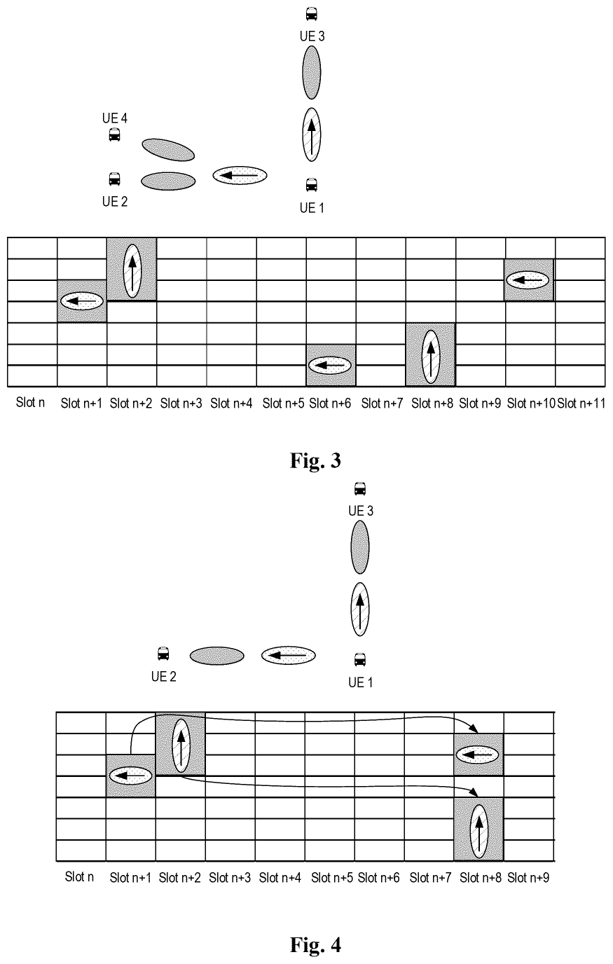

With reference to FIG. 3, an example of Alt.1 is shown in FIG. 3, UE 1 is an example of the first terminal device 201, UE 2 is an example of the second terminal device 202, UE 3 is an example of the other terminal devices, for which the reception beam of the first terminal device is different from the reception beam of the first terminal device for the second terminal device, and UE4 is an example of the third terminal device.

When the UE 2 would perform transmissions to the UE 1. The UE 1 may transmit its preferred resources based on the reservations from other UEs and the associated RX beams. For example, the UE1 has received the reservations from the UE 3 and the UE 4, the associated RX beam of the UE 3's reservations in slot n+2 and slot n+8 is different to the associated RX beam of the UE 2's transmission, the associated RX beams of the UE4's reservations in slot n+1, slot n+6 and slot n+10 are the same as the associated RX beam of the UE 2's transmission, and there are no reservations detected in other slots. Then when the UE 1 is determining the preferred resources for the UE 2's transmission, the resources in slot+2 and slot n+8 should be excluded. The UE 1 may determine the preferred resources from the remaining slots. How to determine the preferred resources for the UE 2's transmission could be as in options 1, 2 and 3, for example, as in the option 1, the UE 1 could determine resources in slot n+1, n+6 and n+10 as the preferred resources since it has received the reservations from other UEs with same associated RX beam.

As to Alt.2, in some embodiments, the first UE (RX UE) may transmit an indicator to the second UE (a TX UE) to inform the second UE it cannot perform reception of the reserved resource due to the collision of RX beam with a reservation from another TX UE (may be referred to as a third UE in the embodiments corresponding to Alt.2). Alt.2 are further described in detail below.

In some embodiments, the first UE may receive a second resource reservation from the second UE and a third resource reservation from the third UE, if the associated RX beam with the second UE and the third UE are different (that is to say, the first UE could not operate on a single beam to perform receptions from the second UE and the third UE at the same time), the first UE could determine that RX beam collision between a second reserved resource and a third reserved resource would happen, and then the first UE may transmit an indicator to the second UE or the third UE to inform such RX beam collision. In these embodiments, the second resource reservation or the second reserved resource may be an example of the second set of resources reserved for the second terminal device 202. The third resource reservation or the third reserved resource may be an example of the first set of resources reserved for the third terminal device.

In some embodiments, on which UE the first UE should transmit the RX beam collision indicator (indicator for short) to, following options could be considered:

In some embodiments, option 1: the lower priority between the second resource reservation and the third resource reservation, the first UE transmits the RX beam collision indicator to the UE with lower priority, this option 1 has benefit to protect the transmission with higher priority. The option 1 may be an example of the embodiments that the at least one indication is transmitted in the case that a priority of the second set of resources is lower than a priority of the first set of resources.

In some embodiments, option 2: the number of reservations covered by each associated RX beam, e.g., if the RX beam associated with second UE could cover more reservations than the RX beam associated with the third UE, the first UE transmits the RX beam collision to the third UE, this option has benefit to protect more sidelink transmissions. The option 2 may be an example of the embodiments that the at least one indication is transmitted in the case that a number of resources among the second set of resources is less than a number of resources among the first set of resources.

In some embodiments, on the second UE side, the behavior with the reception of RX beam collision is described blew. In some embodiments, if one UE receives the RX beam collision indicator, the UE shall perform resource reselection of the reserved resources associated with indicated collision, and the UE may further exclude all the resources in the slot in which the RX beam collision will happen. In some embodiments, the UE receives the RX beam collision indicator may be an example of the second terminal device 202. As mentioned above, the second terminal device 202 may receive, from the first terminal device 201 via a transceiver, at least one indication indicative of the reception beams collision, and during the resource selection, the second terminal device 202 may determine a set selected resources from a candidate resource set excluding resources associated with the reception beams collision.

With reference to FIG. 4, an example of Alt.2 is shown in FIG. 4, UE 1 is an example of the first terminal device 201, UE 2 is an example of the second terminal device 202, UE3 is an example of the third terminal device. The UE 1 may receive resource reservations from the UE 2 and the UE 3 in slot n+8, however the associated RX beams for the reservations from the UE 2 and UE 3 are different, then the UE 1 would transmit the indicator to inform the UE 2 or the UE 3 such RX beam collision. The UE 1 may determine to transmit the indicator to the UE 2 or the UE 3 as in option 1 or option 2 of Alt.2. In some embodiments, for example, if there is also another reservation could be covered by the RX beam associated with the UE 2, then UE 1 shall transmit the indicator to the UE 3.

As to Alt.3, in some embodiments, the first UE (RX UE) needs to perform PSSCH receptions from multiple TX UEs with different RX beams at the same time, e.g., Alt.1 and Alt.2 are not supported by the UE. In this case the RX UE needs to determine its RX beam to receive the multiple PSSCH on reserved resources in one slot. Following options may be considered. The first UE may be an example of the first terminal device 201.

In some embodiments, option 1: the first terminal device 201 may determine the reception beam based on a priority associated with a set of resources in one slot. For example, in some embodiments, the first UE may determine the RX beam for reception based on the priority associated with the reservations in one slot. In some embodiments, the first UE may determine the RX beam associated with UE with highest priority among multiple resource reservations from multiple TX UEs.

In some embodiments, option 2: the first terminal device 201 may determine the reception beam based on number of a set of resources could be covered by the associated beam. For example, in some embodiments, the first UE may determine the RX beam for the reception based on the number of reservations could be covered by the associated beam. For example, if the first UE has received multiple reservations in one slot, and some reservations could be covered by one RX beam, then the first UE may determine its RX beam to perform reception with largest reservations could be covered by that RX beam.

In this disclosure, some alternatives for the reception of PSSCHs from different UEs with analog beamforming are provided: The RX UE transmits a set of preferred resources to the TX UE to assist the resource selection of the TX UE, the preferred resources shall be determined based on the reservations of other UEs and the associated RX beam of the reservations and the associated RX beam of the TX UE; The RX UE transmits an indicator to inform the TX UE that the associated RX beam of the reserved resource is conflict with the associated RX beam of the reservations from other UEs; The RX UE determines to perform sidelink reception with one RX beam based on priority or the number of reservations could be covered by that beam. In this way, the RX UE may receive a plurality of transmissions from different directions in one sidelink slot at the same time for analog beamforming.

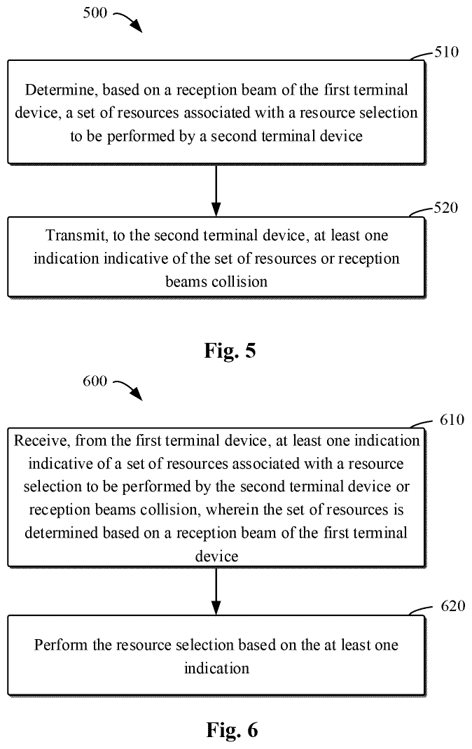

FIG. 5 illustrates a flowchart of an example method 500 for communication in accordance with some embodiments of the present disclosure. As shown in FIG. 5, at block 510, the first terminal device 201 may determine, based on a reception beam of the first terminal device 201, a set of resources associated with a resource selection to be performed by a second terminal device 202. At block 520, the first terminal device 201 may transmit, to the second terminal device 202, at least one indication indicative of the set of resources or reception beams collision.

In some embodiments, the first terminal device 201 may comprise a processor and a transceiver coupled to the processor. The first terminal device 201 may transmit the at least one indication via the transceiver.

In some embodiments, the set of resources may be determined based on a first set of resources in a set of slots reserved for a third terminal device, for which the reception beam of first terminal device 201 is associated with the reception beam for the second terminal device 202.

Additionally, in some embodiments, the set of resources may be determined based on a second set of resources in a set of slots which are not reserved for a transmission to the first terminal device 201.

In some embodiments, the set of resources may be determined based on excluding a third set of resources in a set of slots, and the third set of resources which are reserved for other terminal devices, for which the reception beam of the first terminal device is different from the reception beam of the first terminal device for the second terminal device 202.

In some embodiments, in order to determine the set of resources, the first terminal device 201 may select part or all of resources from the first set of resources.

In some embodiments, in order to determine the set of resources, the first terminal device 201 may select part or all of resources from the first set of resources and the second set of resources.

In some embodiments, in order to determine the set of resources, the first terminal device 201 may select the set of resources from the first set of resources, in the case that a number of the first set of resources is not below a predefined threshold number or ratio.

In some embodiments, in order to determine the set of resources, the first terminal device 201 may select the set of resources from the first set of resources and the second set of resources, in the case that a number of the first set of resources is below a predefined threshold number or ratio.

In some embodiments, the first terminal device 201 transmits the at least one indication, specifically, the first terminal device 201 may transmit a first indication indicative of a first subset of resources selected from the first set of resources and a second indication indicative of a second subset of resources selected from the second set of resources. In some other embodiments, the first terminal device 201 may transmit an indication indicative of resources selected from the first set of resources and the second set of resources.

In some embodiments, the at least one indication may comprise a bitmap. Alternatively, or additionally, the at least one indication may comprise a combination of a time resource indicator value and a frequency resource indicator value.

In some embodiments, the first terminal device 201 may transmit, to the second terminal device 202 via the transceiver, capability information of the first terminal device 201 whether analog beamforming is supported at the first terminal device 201.

In some embodiments, in the case that a reception beam associated with a fourth set of resources in a set of slots reserved for the second terminal device 202 is different with a reception beam associated with a fifth set of resources in the set of slots reserved for a third terminal device, the first terminal device 201 may transmit the at least one indication indicative of the reception beams collision.

In some embodiments, the at least one indication may be transmitted in the case that a priority associated with the fourth set of resources is lower than a priority associated with the fifth set of resources.

In some embodiments, the at least one indication may be transmitted in the case that a number of resources among the fourth set of resources is less than a number of resources among the fifth set of resources.

FIG. 6 illustrates a flowchart of an example method 600 for communication in accordance with some other embodiments of the present disclosure. As shown in FIG. 6, at block 610, the second terminal device 202 may receive, from the first terminal device 201, at least one indication indicative of a set of resources associated with a resource selection to be performed by the second terminal device 202 or reception beams collision, wherein the set of resources is determined based on a reception beam of the first terminal device 201. At block 620, the second terminal device 202 may perform the resource selection based on the at least one indication.

In some embodiments, the second terminal device 202 may comprise a processor, and a transceiver coupled to the processor. The second terminal device 202 may receive the at least one indication via the transceiver.

In some embodiments, the set of resources may comprise part or all of resources from a first set of resources in a set of slots, and the first set of resources are reserved for a third terminal device, for which the reception beam of first terminal device is associated with the reception beam for the second terminal device 202.

In some embodiments, the set of resources may comprise part or all of resources from the first set of resources in the case that a number of the first set of resources is not below a predefined threshold number or ratio.

In some embodiments, the set of resources may comprise part or all of resources from a second set of resources in a set of slots which are not reserved for a transmission to the first terminal device 201.

In some embodiments, the set of resources may be determined based on excluding a third set of resources in a set of slots which are reserved for other terminal devices, for which the reception beam of the first terminal device 201 is different from the reception beam of the first terminal device 201 for the second terminal device 202.

In some embodiments, in the case that a number of the first set of resources is below a predefined threshold number or ratio, the set of resources may comprise all of resources from the first set of resources, and part or all of resources from the second set of resources.

In some embodiments, in order to receive the at least one indication, the second terminal device 202 may receive a first indication indicative of a first subset of resources selected from the first set of resources and a second indication indicative of a second subset of resources selected from the second set of resources. In some other embodiments, in order to receive the at least one indication, the second terminal device 202 may receive an indication indicative of resources selected from the first set of resources and the second set of resources.

In some embodiments, the at least one indication may comprise a bitmap. In some other embodiments, the at least one indication may comprise a combination of a time resource indicator value and a frequency resource indicator value.

In some embodiments, the second terminal device 202 may receive, from the first terminal device 201 via the transceiver, capability information of the first terminal device 201 whether analog beamforming is supported at the first terminal device 201.

In some embodiments, the second terminal device 202 performs the resource selection, specifically, the second terminal device 202 may exclude a plurality of resources not comprised in the set of resources from a candidate resource set, and may determine a set of selected resources from the candidate resource set excluding the plurality of resources.

In some embodiments, in the case that a reception beam associated with a fourth set of resources in a set of slots reserved for the second terminal device 202 is different with a reception beam associated with a fifth set of resources in the set of slots reserved for a third terminal device, the second terminal device 202 may receive the at least one indication indicative of the reception beams collision.

In some embodiments, the at least one indication may be received in the case that a priority associated with the fourth set of resources is lower than a priority associated with the fifth set of resources.

In some embodiments, the at least one indication may be received in the case that a number of resources among the fourth set of resources is less than a number of resources among the fifth set of resources.

In some embodiments, the second terminal device 202 performs the resource selection, specifically, the second terminal device 202 may determine a set selected resources from a candidate resource set excluding resources associated with the reception beams collision.

### Example Apparatus

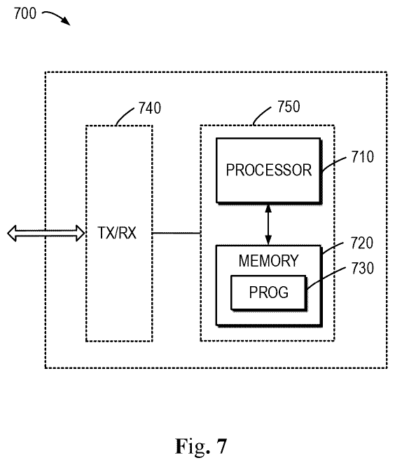

FIG. 7 illustrates a simplified block diagram of a device 700 that is suitable for implementing embodiments of the present disclosure. The device 700 can be considered as a further example implementation of the terminal device 110 or 120 as shown in FIG. 1. Accordingly, the device 700 can be implemented at or as at least a part of the terminal device 110 or 120.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 730 is assumed to include program instructions that, when executed by the associated processor 710, enable the device 700 to operate in accordance with the embodiments of the present disclosure, as discussed herein with reference to FIGS. 1-6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, an apparatus capable of performing the method 500 or 600 (for example, the terminal device 110 or 120) may comprise means for performing the respective steps of the method 500 or 600. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 500 or 600.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first terminal device for wireless communication, comprising:
at least one memory; and
at least one processor coupled with the at least one memory and configured to cause the first terminal device to:
determine, based on a reception beam of the first terminal device, a set of resources associated with a resource selection to be performed by a second terminal device; and
transmit, to the second terminal device, at least one indication indicative of the set of resources or reception beams collision.

2. The first terminal device of claim 1, wherein the set of resources are determined based on:
a first set of resources in a set of slots reserved for a third terminal device, for which the reception beam of first terminal device is associated with the reception beam for the second terminal device.

3. The first terminal device of claim 2, wherein the set of resources are determined based on:
a second set of resources in a set of slots that are not reserved for a transmission to the first terminal device.

4. The first terminal device of claim 1, wherein the set of resources are determined based on excluding a third set of resources in a set of slots that are reserved for other terminal devices, for which the reception beam of the first terminal device is different from the reception beam of the first terminal device for the second terminal device.

5. The first terminal device of claim 2, wherein determining the set of resources comprises:
selecting part or all of resources from the first set of resources.

6. The first terminal device of claim 3, wherein determining the set of resources comprises:
selecting part or all of resources from the first set of resources and the second set of resources.

7. The first terminal device of claim 3, wherein determining the set of resources comprises:
selecting the set of resources from the first set of resources when a number of the first set of resources is not below a predefined threshold number or ratio.

8. The first terminal device of claim 3, wherein determining the set of resources comprises:
selecting the set of resources from the first set of resources and the second set of resources when a number of the first set of resources is below a predefined threshold number or ratio.

9. The first terminal device of claim 8, wherein transmitting the at least one indication comprises:
transmitting a first indication indicative of a first subset of resources selected from the first set of resources and a second indication indicative of a second subset of resources selected from the second set of resources; or
transmitting an indication indicative of resources selected from the first set of resources and the second set of resources.

10. The first terminal device of claim 1, wherein the at least one indication comprises:
a bitmap; or
a combination of a time resource indicator value and a frequency resource indicator value.

11. The first terminal device of claim 1, wherein the at least one processor is further configured to cause the first terminal device to:
transmit, to the second terminal device, capability information of the first terminal device associated with whether analog beamforming is supported at the first terminal device.

12. The first terminal device of claim 1, wherein,
when a reception beam associated with a fourth set of resources in a set of slots reserved for the second terminal device is different from a reception beam associated with a fifth set of resources in the set of slots reserved for a third terminal device, transmitting the at least one indication indicative of a reception beams collision.

13. The first terminal device of claim 12, wherein the at least one indication is transmitted when a priority associated with the fourth set of resources is lower than a priority associated with the fifth set of resources.

14. The first terminal device of claim 12, wherein the at least one indication is transmitted when a number of resources among the fourth set of resources is less than a number of resources among the fifth set of resources.

15. A second terminal device for wireless communication, comprising:
at least one memory; and
at least one processor coupled with the at least one memory and configured to cause the second terminal device to:
receive, from a first terminal device, at least one indication indicative of a set of resources associated with a resource selection to be performed by the second terminal device or reception beams collision, wherein the set of resources is determined based on a reception beam of the first terminal device; and
perform the resource selection based on the at least one indication.

16. The second terminal device of claim 15, wherein the set of resources comprises part or all of resources from a first set of resources in a set of slots, and the first set of resources are reserved for a third terminal device, for which the reception beam of first terminal device is associated with the reception beam for the second terminal device.

17. The second terminal device of claim 16, wherein the set of resources comprises part or all of resources from a second set of resources in a set of slots which are not reserved for a transmission to the first terminal device.

18. The second terminal device of claim 17, wherein the set of resources comprises part or all of resources from the first set of resources when a number of the first set of resources is not below a predefined threshold number or ratio.

19.-28. (canceled)

29. A method performed by a first terminal device, the method comprising:
determining, based on a reception beam of the first terminal device, a set of resources associated with a resource selection to be performed by a second terminal device; and
transmitting, to the second terminal device via a transceiver, at least one indication indicative of the set of resources or reception beams collision.

30. A method performed by a second terminal device, the method comprising:
receiving, from a first terminal device via a transceiver, at least one indication indicative of a set of resources associated with a resource selection to be performed by the second terminal device or reception beams collision, wherein the set of resources is determined based on a reception beam of the first terminal device; and
performing the resource selection based on the at least one indication.

31.-32. (canceled)
